(19) United States
(12) Patent Application Publication
(10) Pub. No.: US 2023/0142544 A1
(43) Pub. Date: May 11, 2023

(54) System and Method for Mutual Discovery in Autonomous Rideshare Between Passengers and Vehicles

(71) Applicant: Argo AI, LLC, Pittsburgh, PA (US)

(72) Inventor: Kleanthes George Koniaris, San Francisco, CA (US)

(21) Appl. No.: 17/524,248

(22) Filed: Nov. 11, 2021

(51) Int. Cl. B60W 60/00; G05D 1/02; B60W 50/14; G06Q 10/06

(52) U.S. Cl. CPC B60W 60/00253; G05D 1/0274; G05D 1/0285; B60W 50/14; G06Q 10/0631; B60W 2556/45; B60W 2420/42; B60W 2050/143; B60W 2050/146; B60W 2540/041

(57) ABSTRACT

Systems and methods for mutual discovery in autonomous rideshare between passengers and vehicles may receive a pick-up request to pick-up a user with an autonomous vehicle and interact with the user to perform an operation associated with the autonomous vehicle and/or update a user profile associated with the user.

### BACKGROUND

### 1. Field

This disclosure relates generally to autonomous vehicles and, in some non-limiting embodiments or aspects, to mutual discovery between passengers and autonomous vehicles.

### 2. Technical Considerations

Rideshare services heavily leverage the intelligence of human drivers during passenger ingress and egress. For example, it is common for a customer to call a driver before the arrival of the driver to give specific instructions to the driver. Conversely, the driver may call the customer for any necessary clarification. Although an autonomous vehicle based rideshare service may have human operators that can appropriately guide the autonomous vehicle and/or call on behalf of the autonomous vehicle to ask the customer questions, for scalability and customer satisfaction reasons it may be desirable to make such interventions as rare as possible.

A rideshare experience may start with a user using an application on a user device to summon a vehicle to pick-up the user. Eventually, a rideshare vehicle arrives, and the user must somehow reach and enter the vehicle, ideally without frustration or confusion. In suburban environments, reaching and entering the vehicle may be a simple process, as there is likely only one candidate vehicle. In cities, airports, and other areas with a large flux of vehicles, a user may have difficultly identifying a correct vehicle, particularly if the vehicles are similarly branded (e.g., painted a same way, etc.). In rural areas, it may be difficult to specify an exact location at which a pick-up is desired. Further, the nascent self-driving rideshare industry has not yet witnessed crimes, such as kidnapping of a user by tricking the user into entering a fake vehicle, and/or the like, but these crimes may be forthcoming if technology permits their existence.

### SUMMARY

Accordingly, provided are improved systems, methods, products, apparatuses, and/or devices of a process for mutual discovery between passengers and autonomous vehicles. For example non-limiting embodiments or aspects of the present disclosure may enable users and autonomous vehicles to quickly and reliably identify each other in complex situations in which there are many people and/or vehicles nearby, thereby providing for a better rideshare experience including a more effortless customer ingress into an appropriate autonomous vehicle.

According to some non-limiting embodiments or aspects, provided are systems and methods that receive a pick-up request to pick-up a user with an autonomous vehicle; provide, to a user device associated with the user, a map of a geographic location in which the autonomous vehicle is currently located, wherein the map includes a plurality of sectors corresponding to a plurality of fields of view of a plurality of image capture devices of the autonomous vehicle; receive, from the user device, user input data associated with a selection of a sector of the plurality of sectors in the map; and in response to receiving the user input data associated with the selection of the sector of the plurality of sectors from the user device, provide, to the user device, one or more images from an image capture device of the plurality of image capture devices corresponding to the selected sector of the plurality of sectors.

According to some non-limiting embodiments or aspects, provided are systems and method that receive, a pick-up request to pick-up a user with an autonomous vehicle; obtain, sensor data associated with an environment surrounding the autonomous vehicle; and control, in response to a location of the user satisfying a threshold location with respect to a door of the autonomous vehicle, the autonomous vehicle to unlock the door, wherein the location of the user is determined based on the sensor data.

Non-limiting embodiments or aspects are set forth in the following numbered clauses:

Clause 1. A computer-implemented method, comprising: receiving, with at least one processor, a pick-up request to pick-up a user with an autonomous vehicle; providing, with the at least one processor, to a user device associated with the user, a map of a geographic location in which the autonomous vehicle is currently located, wherein the map includes a plurality of sectors corresponding to a plurality of fields of view of a plurality of image capture devices of the autonomous vehicle; receiving, with the at least one processor, from the user device, user input data associated with a selection of a sector of the plurality of sectors in the map; and in response to receiving the user input data associated with the selection of the sector of the plurality of sectors from the user device, providing, with the at least one processor, to the user device, one or more images from an image capture device of the plurality of image capture devices corresponding to the selected sector of the plurality of sectors.

Clause 2. The computer-implemented method of clause 1, further comprising: receiving, with the at least one processor, from the user device, further user input data associated with a request to view an interior of the autonomous vehicle; and in response to receiving the request to view the interior of the autonomous vehicle, providing, with the at least one processor, to the user device, one or more images of an interior of the autonomous vehicle.

Clause 3. The computer-implemented method of clauses 1 or 2, further comprising: receiving, with the at least one processor, from the user device, further user input data associated with a request to provide an audio and/or visual output from an audio and/or visual output device of the autonomous vehicle; and in response to receiving the request to provide the audio and/or visual output, controlling, with the at least one processor, the audio and/or visual output device of the autonomous vehicle to provide the audio and/or visual output.

Clause 4. The computer-implemented method of any of clauses 1-3, further comprising: receiving, with the at least one processor, from the user device, further user input data associated with an identification of an area in the one or more images; and in response to receiving the identification of the area in the one or more images, setting, with the at least one processor, a geographic location associated with the identified area as a pick-up location for picking-up the user with the autonomous vehicle.

Clause 5. The computer-implemented method of any of clauses 1-4, wherein the user input data associated with selection of the sector of the plurality of sectors includes an audio signal, and wherein receiving the user input data further includes applying a natural language processing (NLP) technique to the audio signal to determine the selection of the sector of the plurality of sectors.

Clause 6. The computer-implemented method of any of clauses 1-5, further comprising: receiving, with the at least one processor, from the user device, further user input data associated with an identification of the user in the one or more images; and determining, with the at least one processor, based on the identified user, a location of the user in an environment surrounding the autonomous vehicle.

Clause 7. The computer-implemented method of any of clauses 1-6, further comprising: obtaining, with the at least one processor, a user profile associated with the user, wherein the user profile includes one or more user preferences associated with the user; and updating, based on the user input data, using a machine learning model, at least one user preference of the user profile associated with the user.

Clause 8. A computer-implemented method, comprising: receiving, with at least one processor, a pick-up request to pick-up a user with an autonomous vehicle; obtaining, with the at least one processor, sensor data associated with an environment surrounding the autonomous vehicle; and controlling, with the at least one processor, in response to a location of the user satisfying a threshold location with respect to a door of the autonomous vehicle, the autonomous vehicle to unlock the door, wherein the location of the user is determined based on the sensor data.

Clause 9. The computer-implemented method of clause 8, wherein the sensor data includes image data associated with one or more images of the environment surrounding the autonomous vehicle, and wherein the location of the user is determined by applying an object recognition technique to the one or more images.

Clause 10. The computer-implemented method of clauses 8 or 9, further comprising: receiving, with the at least one processor, from a user device, user input data associated with an image of the user, wherein the object recognition technique uses the image of the user to identify the user in the one or more images of the environment surrounding the autonomous vehicle.

Clause 11. The computer-implemented method of any of clauses 8-10, wherein obtaining the sensor data further includes receiving, with a plurality of phased array antennas, a Bluetooth signal from a user device associated with the user, wherein the location of the user is determined by applying a Bluetooth Direction Finding technique to the Bluetooth signal.

Clause 12. The computer-implemented method of any of clauses 8-11, wherein the Bluetooth signal includes a request for the autonomous vehicle to confirm that the autonomous vehicle is authentic, and wherein the method further comprises: in response to receiving the Bluetooth signal including the request, transmitting, with the at least one processor, via another Bluetooth signal, to the user device, a confirmation that the autonomous vehicle is authentic.

Clause 13. The computer-implemented method of any of clauses 8-12, further comprising: obtaining, with the at least one processor, a user profile associated with the user, wherein the user profile includes one or more user preferences associated with the user, and wherein the threshold location with respect to the door of the autonomous vehicle is determined based on the one or more user preferences.

Clause 14. The computer-implemented method of any of clauses 8-13, further comprising: receiving, with the at least one processor, from a user device, user input data associated with an image of an environment surrounding the user, wherein the image is associated with a geographic location of the user device at a time the image is captured; and applying, with the at least one processor, an object recognition technique to the image to identify one or more objects in the image, wherein the one or more objects in the image are associated with one or more predetermined geographic locations, and wherein the location of the user is determined based on the sensor data, the one or more predetermined geographic locations of the one or more objects identified in the image, and the geographic location of the user device.

Clause 15. The computer-implemented method of any of clauses 8-14, further comprising: controlling, with the at least one processor, the autonomous vehicle to travel to a pick-up position for picking-up the user, wherein the pick-up position is determined based on the location of the user.

Clause 16. The computer-implemented method of any of clauses 8-15, wherein controlling the autonomous vehicle to travel to the pick-up position further includes providing, to a user device, a prompt for the user to travel to the pick-up position, wherein the prompt includes directions for walking to the pick-up position.

Clause 17. The computer-implemented method of any of clauses 8-16, where the directions for walking to the pick-up position include an augmented reality overlay.

Clause 18. The computer-implemented method of any of clauses 8-17, further comprising: receiving, with the at least one processor, from a user device, user input data associated with an operation of the autonomous vehicle requested by the user, wherein the user input data includes an audio signal; applying, with the at least one processor, a natural language processing (NLP) technique to the audio signal to determine the operation; and controlling, with the at least one processor, the autonomous vehicle to perform the operation.

Clause 19. The computer-implemented method of any of clauses 8-18, further comprising: obtaining, with the at least one processor, a user profile associated with the user, wherein the user profile includes one or more user preferences associated with the user; and updating, based on the user input data, using a machine learning model, at least one user preference of the user profile associated with the user.

Clause 20. The computer-implemented method of any of clauses 8-19, wherein the sensor data includes a near field communication (NFC) signal received from a user device.

Clause 21. A system, comprising: at least one processor configured to: receive a pick-up request to pick-up a user with an autonomous vehicle; provide, to a user device associated with the user, a map of a geographic location in which the autonomous vehicle is currently located, wherein the map includes a plurality of sectors corresponding to a plurality of fields of view of a plurality of image capture devices of the autonomous vehicle; receive, from the user device, user input data associated with a selection of a sector of the plurality of sectors in the map; and in response to receiving the user input data associated with the selection of the sector of the plurality of sectors from the user device, provide, to the user device, one or more images from an image capture device of the plurality of image capture devices corresponding to the selected sector of the plurality of sectors.

Clause 22. The system, of clause 21, wherein the at least one processor is further configured to: receive, from the user device, further user input data associated with a request to view an interior of the autonomous vehicle; and in response to receiving the request to view the interior of the autonomous vehicle, provide, to the user device, one or more images of an interior of the autonomous vehicle.

Clause 23. The system of clauses 21 or 22, wherein the at least one processor is further configured to: receive, from the user device, further user input data associated with a request to provide an audio and/or visual output from an audio and/or visual output device of the autonomous vehicle; and in response to receiving the request to provide the audio and/or visual output, control, the audio and/or visual output device of the autonomous vehicle to provide the audio and/or visual output.

Clause 24. The system of any of clauses 21-23, wherein the at least one processor is further configured to: receive, from the user device, further user input data associated with an identification of an area in the one or more images; and in response to receiving the identification of the area in the one or more images, set, a geographic location associated with the identified area as a pick-up location for picking-up the user with the autonomous vehicle.

Clause 25. The system of any of clauses 21-24, wherein the user input data associated with selection of the sector of the plurality of sectors includes an audio signal, and wherein receiving the user input data further includes applying a natural language processing (NLP) technique to the audio signal to determine the selection of the sector of the plurality of sectors.

Clause 26. The system of any of clauses 21-25, wherein the at least one processor is further configured to: receive, from the user device, further user input data associated with an identification of the user in the one or more images; and determine, based on the identified user, a location of the user in an environment surrounding the autonomous vehicle.

Clause 27. The system of any of clauses 21-26, wherein the at least one processor is further configured to: obtain, a user profile associated with the user, wherein the user profile includes one or more user preferences associated with the user; and update, using a machine learning model, at least one user preference of the user profile associated with the user.

Clause 28. A system, comprising: at least one processor configured to: receive, a pick-up request to pick-up a user with an autonomous vehicle; obtain, sensor data associated with an environment surrounding the autonomous vehicle; and control, in response to a location of the user satisfying a threshold location with respect to a door of the autonomous vehicle, the autonomous vehicle to unlock the door, wherein the location of the user is determined based on the sensor data.

Clause 29. The system of clause 28, wherein the sensor data includes image data associated with one or more images of the environment surrounding the autonomous vehicle, and wherein the location of the user is determined by applying an object recognition technique to the one or more images.

Clause 30. The system of clauses 28 or 29, wherein the at least one processor is further configured to: receive, from a user device, user input data associated with an image of the user, wherein the object recognition technique uses the image of the user to identify the user in the one or more images of the environment surrounding the autonomous vehicle.

Clause 31. The system of any of clauses 28-30, wherein the at least one processor is further configured to obtain the sensor data further by receiving, with a plurality of phased array antennas, a Bluetooth signal from a user device associated with the user, wherein the location of the user is determined by applying a Bluetooth Direction Finding technique to the Bluetooth signal.

Clause 32. The system of any of clauses 28-31, wherein the Bluetooth signal includes a request for the autonomous vehicle to confirm that the autonomous vehicle is authentic, and wherein the at least one processor is further configured to: in response to receiving the Bluetooth signal including the request, transmit, via another Bluetooth signal, to the user device, a confirmation that the autonomous vehicle is authentic.

Clause 33. The system of any of clauses 28-32, wherein the at least one processor is further configured to: obtain a user profile associated with the user, wherein the user profile includes one or more user preferences associated with the user, and wherein the threshold location with respect to the door of the autonomous vehicle is determined based on the one or more user preferences.

Clause 34. The system of any of clauses 28-33, wherein the at least one processor is further configured to: receive, from a user device, user input data associated with an image of an environment surrounding the user, wherein the image is associated with a geographic location of the user device at a time the image is captured; and apply, an object recognition technique to the image to identify one or more objects in the image, wherein the one or more objects in the image are associated with one or more predetermined geographic locations, and wherein the location of the user is determined based on the sensor data, the one or more predetermined geographic locations of the one or more objects identified in the image, and the geographic location of the user device.

Clause 35. The system of any of clauses 28-34, wherein the at least one processor is further configured to: control the autonomous vehicle to travel to a pick-up position for picking-up the user, wherein the pick-up position is determined based on the location of the user.

Clause 36. The system of any of clauses 28-35, wherein the at least one processor is further configured to control the autonomous vehicle to travel to the pick-up position further by providing, to a user device, a prompt for the user to travel to the pick-up position, wherein the prompt includes directions for walking to the pick-up position.

Clause 37. The system of any of clauses 28-36, where the directions for walking to the pick-up position include an augmented reality overlay.

Clause 38. The system of any of clauses 28-37, wherein the at least one processor is further configured to: receive, from a user device, user input data associated with an operation of the autonomous vehicle requested by the user, wherein the user input data includes an audio signal; apply a natural language processing (NLP) technique to the audio signal to determine the operation; and control the autonomous vehicle to perform the operation.

Clause 39. The system of any of clauses 28-38, wherein the at least one processor is further configured to: obtain a user profile associated with the user, wherein the user profile includes one or more user preferences associated with the user; and update, using a machine learning model, at least one user preference of the user profile associated with the user.

Clause 40. The system of any of clauses 28-39, wherein the sensor data includes a near field communication (NFC) signal received from a user device.

Clause 40. A computer program product comprising at least one non-transitory computer-readable medium including program instructions that, when executed by at least one processor, cause the at least one processor to: receive a pick-up request to pick-up a user with an autonomous vehicle; provide, to a user device associated with the user, a map of a geographic location in which the autonomous vehicle is currently located, wherein the map includes a plurality of sectors corresponding to a plurality of fields of view of a plurality of image capture devices of the autonomous vehicle; receive, from the user device, user input data associated with a selection of a sector of the plurality of sectors in the map; and in response to receiving the user input data associated with the selection of the sector of the plurality of sectors from the user device, provide, to the user device, one or more images from an image capture device of the plurality of image capture devices corresponding to the selected sector of the plurality of sectors.

Clause 41. The computer program product of clause 40, wherein the instructions, when executed by the at least one processor, further cause the at least one processor to: receive, from the user device, further user input data associated with a request to view an interior of the autonomous vehicle; and in response to receiving the request to view the interior of the autonomous vehicle, provide, to the user device, one or more images of an interior of the autonomous vehicle.

Clause 42. The computer program product of any of clauses 40 and 41, wherein the instructions, when executed by the at least one processor, further cause the at least one processor to: receive, from the user device, further user input data associated with a request to provide an audio and/or visual output from an audio and/or visual output device of the autonomous vehicle; and in response to receiving the request to provide the audio and/or visual output, control, the audio and/or visual output device of the autonomous vehicle to provide the audio and/or visual output.

Clause 43. The computer program product of any of causes 40-42, wherein the instructions, when executed by the at least one processor, further cause the at least one processor to: receive, from the user device, further user input data associated with an identification of an area in the one or more images; and in response to receiving the identification of the area in the one or more images, set, a geographic location associated with the identified area as a pick-up location for picking-up the user with the autonomous vehicle.

Clause 44. The computer program product of any of clauses 40-43, wherein the user input data associated with selection of the sector of the plurality of sectors includes an audio signal, and wherein receiving the user input data further includes applying a natural language processing (NLP) technique to the audio signal to determine the selection of the sector of the plurality of sectors.

Clause 45. The computer program product of any of clauses 40-44, wherein the instructions, when executed by the at least one processor, further cause the at least one processor to: receive, from the user device, further user input data associated with an identification of the user in the one or more images; and determine, based on the identified user, a location of the user in an environment surrounding the autonomous vehicle.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, methods, products, apparatuses, and/or devices, described herein, may be implemented;

FIG. 2 is an illustration of an illustrative architecture for a vehicle;

FIG. 3 is an illustration of an illustrative architecture for a LiDAR system;

FIG. 4 is an illustration of an illustrative computing device;

FIG. 5 is a flowchart of non-limiting embodiments or aspects of a process for mutual discovery between passengers and autonomous vehicles;

FIG. 6 is a flowchart of non-limiting embodiments or aspects of a process for mutual discovery between passengers and autonomous vehicles;

FIG. 7A is an illustration of non-limiting embodiments or aspects of a map including sectors corresponding to fields of view of image capture devices of an autonomous vehicle;

FIG. 7B is an illustration of non-limiting embodiments or aspects of a view from an image capture device; and

FIG. 8 is a flowchart of non-limiting embodiments or aspects of a process for mutual discovery between passengers and autonomous vehicles.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, a refrigerator, a thermostat, and/or the like), a computer, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “server” and/or “processor” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “user interface” or “graphical user interface” may refer to a generated display, such as one or more graphical user interfaces (GUIs) with which a user may interact, either directly or indirectly (e.g., through a keyboard, mouse, touchscreen, etc.).

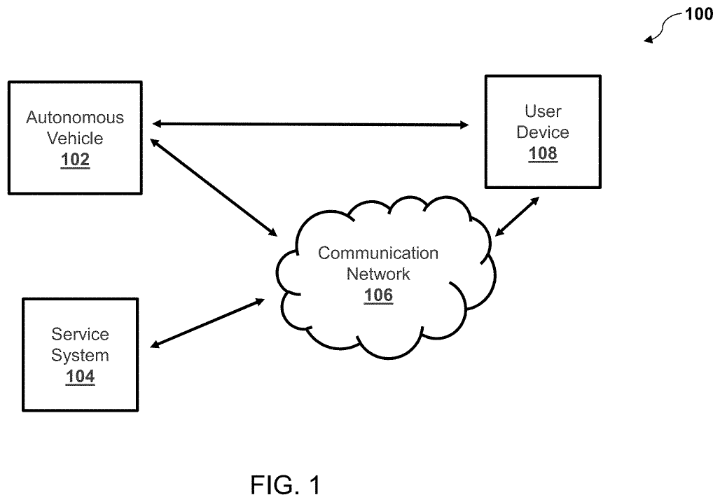

Referring now to FIG. 1, FIG. 1 is a diagram of an example environment 100 in which systems, methods, products, apparatuses, and/or devices described herein, may be implemented. As shown in FIG. 1, environment 100 may include autonomous vehicle 102, service system 104, communication network 106, and/or user device 108.

Autonomous vehicle 102 may include one or more devices capable of receiving information and/or data from service system 104 and/or user device 108 (e.g., via communication network 106, etc.) and/or communicating information and/or data to service system 104 and/or user device 108 (e.g., via communication network 106, etc.). For example, autonomous vehicle 102 may include a computing device, such as a server, a group of servers, and/or other like devices. In some non-limiting embodiments or aspects, autonomous vehicle 102 may include a device capable of receiving information and/or data from user device 108 via a short range wireless communication connection (e.g., an NFC communication connection, an RFID communication connection, a Bluetooth® communication connection, etc.) with user device 108 and/or communicating information and/or data to user device 108 via the short range wireless communication connection.

Service system 104 may include one or more devices capable of receiving information and/or data from autonomous vehicle 102 and/or user device 108 (e.g., via communication network 106, etc.) and/or communicating information and/or data to autonomous vehicle 102 and/or user device 108 (e.g., via communication network 106, etc.). For example, service system 104 may include a computing device, such as a server, a group of servers, and/or other like devices.

Service system 104 may provide services for an application platform, such as a ride sharing platform. For example, service system 104 may communicate with user device 108 to provide user access to the application platform, and/or service system 104 may communicate with autonomous vehicle 102 (e.g., system architecture 200, etc.) to provision services associated with the application platform, such as a ride sharing services. Service system 104 may be associated with a central operations system and/or an entity associated with autonomous vehicle 102 and/or the application platform such as, for example, a vehicle owner, a vehicle manager, a fleet operator, a service provider, etc.

Communication network 106 may include one or more wired and/or wireless networks. For example, communication network 106 may include a cellular network (e.g., a long-term evolution (LTE) network, a third generation (3G) network, a fourth generation (4G) network, a fifth generation (5G) network a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

User device 108 may include one or more devices capable of receiving information and/or data from autonomous vehicle 102 and/or service system 104 (e.g., via communication network 106, etc.) and/or communicating information and/or data to autonomous vehicle 102 and/or service system 104 (e.g., via communication network 106, etc.). For example, user device 108 may include a client device, a mobile device, and/or the like. In some non-limiting embodiments or aspects, user device 108 may be capable of receiving information (e.g., from autonomous vehicle 102, etc.) via a short range wireless communication connection (e.g., an NFC communication connection, an RFID communication connection, a Bluetooth® communication connection, and/or the like), and/or communicating information (e.g., to autonomous vehicle 102, etc.) via a short range wireless communication connection.

User device 108 may provide a user with access to an application platform, such as a ride sharing platform, and/or the like, which enables the user to establish/maintain a user account for the application platform, request services associated with the application platform, and/or establish/maintain a user profile including preferences for the provided services.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. For example, autonomous vehicle 102 may incorporate the functionality of service system 104 such that autonomous vehicle 102 can operate without communication to or from service system 104. Additionally, or alternatively, a set of devices and/or systems (e.g., one or more devices or systems) of environment 100 may perform one or more functions described as being performed by another set of devices and/or systems of environment 100.

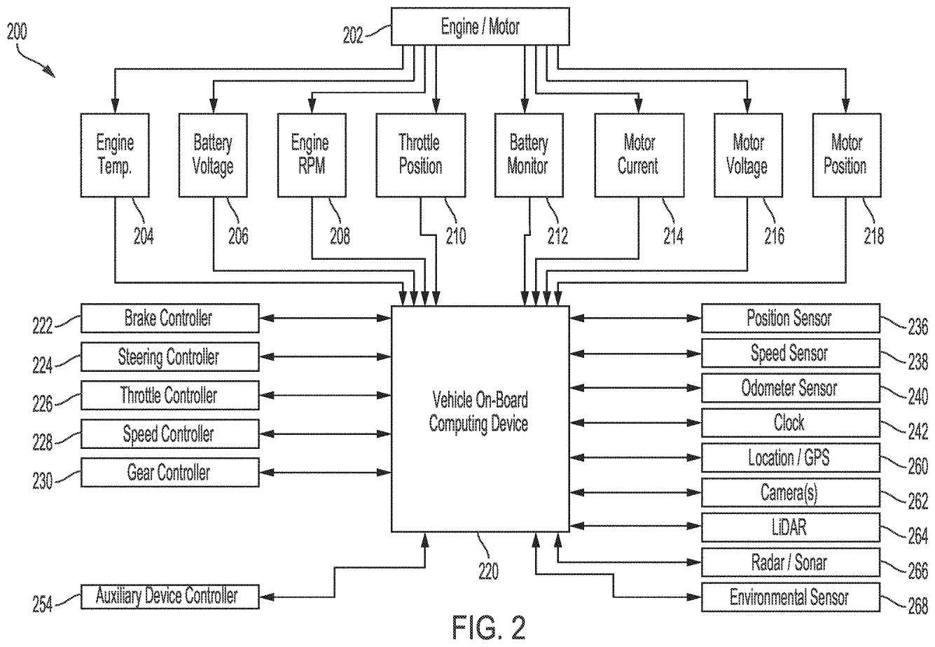

Referring now to FIG. 2, FIG. 2 is an illustration of an illustrative system architecture 200 for a vehicle. Autonomous vehicle 102 may include a same or similar system architecture as that of system architecture 200 shown in FIG. 2.

As shown in FIG. 2, system architecture 200 may include engine or motor 202 and various sensors 204-218 for measuring various parameters of the vehicle. In gas-powered or hybrid vehicles having a fuel-powered engine, the sensors may include, for example, engine temperature sensor 204, battery voltage sensor 206, engine Rotations Per Minute (“RPM”) sensor 208, and/or throttle position sensor 210. In an electric or hybrid vehicle, the vehicle may have an electric motor, and may have sensors such as battery monitoring sensor 212 (e.g., to measure current, voltage, and/or temperature of the battery), motor current sensor 214, motor voltage sensor 216, and/or motor position sensors 218, such as resolvers and encoders.

System architecture 200 may include operational parameter sensors, which may be common to both types of vehicles, and may include, for example: position sensor 236 such as an accelerometer, gyroscope and/or inertial measurement unit; speed sensor 238; and/or odometer sensor 240. System architecture 200 may include clock 242 that the system 200 uses to determine vehicle time during operation. Clock 242 may be encoded into the vehicle on-board computing device 220, it may be a separate device, or multiple clocks may be available.

System architecture 200 may include various sensors that operate to gather information about an environment in which the vehicle is operating and/or traveling. These sensors may include, for example: location sensor 260 (e.g., a Global Positioning System (“GPS”) device); object detection sensors such as one or more cameras 262; LiDAR sensor system 264; and/or radar and/or sonar system 266. The sensors may include environmental sensors 268 such as a precipitation sensor and/or ambient temperature sensor. The object detection sensors may enable the system architecture 200 to detect objects that are within a given distance range of the vehicle in any direction, and the environmental sensors 268 may collect data about environmental conditions within an area of operation and/or travel of the vehicle.

During operation of system architecture 200, information is communicated from the sensors of system architecture 200 to on-board computing device 220. On-board computing device 220 analyzes the data captured by the sensors and optionally controls operations of the vehicle based on results of the analysis. For example, on-board computing device 220 may control: braking via a brake controller 222; direction via steering controller 224; speed and acceleration via throttle controller 226 (e.g., in a gas-powered vehicle) or motor speed controller 228 such as a current level controller (e.g., in an electric vehicle); differential gear controller 230 (e.g., in vehicles with transmissions); and/or other controllers such as auxiliary device controller 254.

Geographic location information may be communicated from location sensor 260 to on-board computing device 220, which may access a map of the environment including map data that corresponds to the location information to determine known fixed features of the environment such as streets, buildings, stop signs and/or stop/go signals, and/or vehicle constraints (e.g., driving rules or regulations, etc.). Captured images and/or video from cameras 262 and/or object detection information captured from sensors such as LiDAR sensor system 264 is communicated from those sensors to on-board computing device 220. The object detection information and/or captured images are processed by on-board computing device 220 to detect objects in proximity to the vehicle. Any known or to be known technique for making an object detection based on sensor data and/or captured images can be used in the embodiments disclosed in this document.

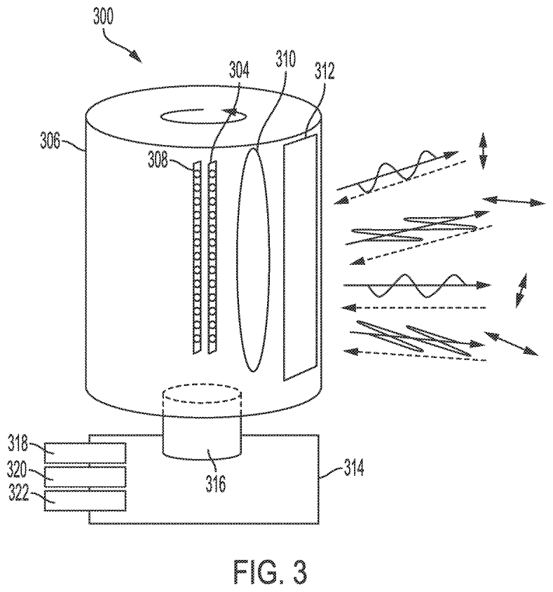

Referring now to FIG. 3, FIG. 3 is an illustration of an illustrative LiDAR system 300. LiDAR sensor system 264 of FIG. 2 may be the same as or substantially similar to LiDAR system 300.

As shown in FIG. 3, LiDAR system 300 may include housing 306, which may be rotatable 360° about a central axis such as hub or axle 315. Housing 306 may include an emitter/receiver aperture 312 made of a material transparent to light. Although a single aperture is shown in FIG. 3, non-limiting embodiments or aspects of the present disclosure are not limited in this regard. In other scenarios, multiple apertures for emitting and/or receiving light may be provided. Either way, LiDAR system 300 can emit light through one or more of aperture(s) 312 and receive reflected light back toward one or more of aperture(s) 312 as housing 306 rotates around the internal components. In an alternative scenario, the outer shell of housing 306 may be a stationary dome, at least partially made of a material that is transparent to light, with rotatable components inside of housing 306.

Inside the rotating shell or stationary dome is a light emitter system 304 that is configured and positioned to generate and emit pulses of light through aperture 312 or through the transparent dome of housing 306 via one or more laser emitter chips or other light emitting devices. Light emitter system 304 may include any number of individual emitters (e.g., 8 emitters, 64 emitters, 128 emitters, etc.). The emitters may emit light of substantially the same intensity or of varying intensities. The individual beams emitted by light emitter system 304 may have a well-defined state of polarization that is not the same across the entire array. As an example, some beams may have vertical polarization and other beams may have horizontal polarization. LiDAR system 300 may include light detector 308 containing a photodetector or array of photodetectors positioned and configured to receive light reflected back into the system. Light emitter system 304 and light detector 308 may rotate with the rotating shell, or light emitter system 304 and light detector 308 may rotate inside the stationary dome of housing 306. One or more optical element structures 310 may be positioned in front of light emitter system 304 and/or light detector 308 to serve as one or more lenses and/or waveplates that focus and direct light that is passed through optical element structure 310.

One or more optical element structures 310 may be positioned in front of a mirror to focus and direct light that is passed through optical element structure 310. As described herein below, LiDAR system 300 may include optical element structure 310 positioned in front of a mirror and connected to the rotating elements of LiDAR system 300 so that optical element structure 310 rotates with the mirror. Alternatively or in addition, optical element structure 310 may include multiple such structures (e.g., lenses, waveplates, etc.). In some non-limiting embodiments or aspects, multiple optical element structures 310 may be arranged in an array on or integral with the shell portion of housing 306.

In some non-limiting embodiments or aspects, each optical element structure 310 may include a beam splitter that separates light that the system receives from light that the system generates. The beam splitter may include, for example, a quarter-wave or half-wave waveplate to perform the separation and ensure that received light is directed to the receiver unit rather than to the emitter system (which could occur without such a waveplate as the emitted light and received light should exhibit the same or similar polarizations).

LiDAR system 300 may include power unit 318 to power the light emitter system 304, motor 316, and electronic components. LiDAR system 300 may include an analyzer 314 with elements such as processor 322 and non-transitory computer-readable memory 320 containing programming instructions that are configured to enable the system to receive data collected by the light detector unit, analyze the data to measure characteristics of the light received, and generate information that a connected system can use to make decisions about operating in an environment from which the data was collected. Analyzer 314 may be integral with the LiDAR system 300 as shown, or some or all of analyzer 314 may be external to LiDAR system 300 and communicatively connected to LiDAR system 300 via a wired and/or wireless communication network or link.

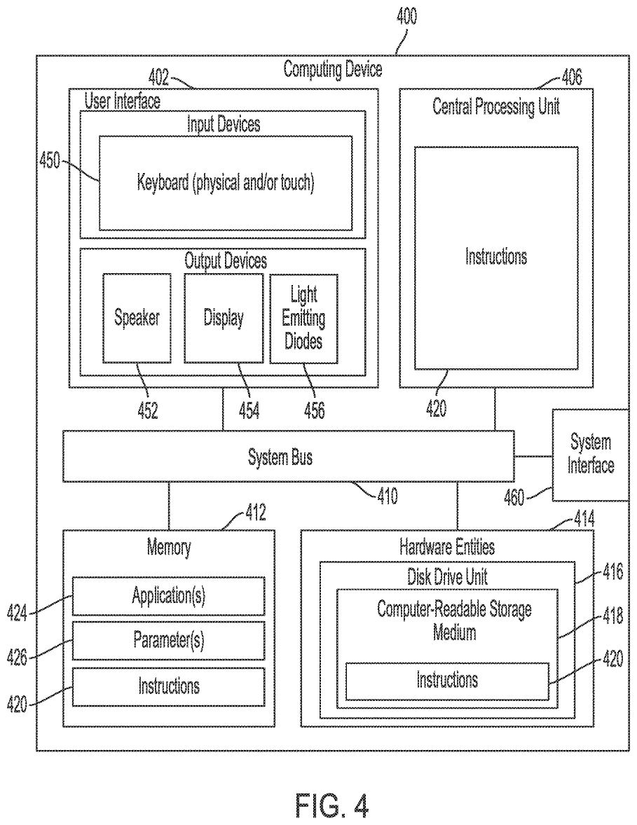

Referring now to FIG. 4, FIG. 4 is an illustration of an illustrative architecture for a computing device 400. Computing device 400 can correspond to one or more devices of (e.g., one or more devices of a system of) autonomous vehicle 102 (e.g., one more devices of system architecture 200, etc.) one or more devices of service system 104, and/or one or more devices of (e.g., one or more devices of a system of) user device 108. In some non-limiting embodiments or aspects, one or more devices of (e.g., one or more devices of a system of) autonomous vehicle 102 (e.g., one or more devices of system architecture 200, etc.), one or more devices of service system 104, and/or one or more devices of (e.g., one or more devices of a system of) user device 108 can include at least one computing device 400 and/or at least one component of computing device 400.

The number and arrangement of components shown in FIG. 4 are provided as an example. In some non-limiting embodiments or aspects, computing device 400 may include additional components, fewer components, different components, or differently arranged components than those shown in FIG. 4. Additionally, or alternatively, a set of components (e.g., one or more components) of computing device 400 may perform one or more functions described as being performed by another set of components of device 400.

As shown in FIG. 4, computing device 400 comprises user interface 402, Central Processing Unit (“CPU”) 406, system bus 410, memory 412 connected to and accessible by other portions of computing device 400 through system bus 410, system interface 460, and hardware entities 414 connected to system bus 410. User interface 402 can include input devices and output devices, which facilitate user-software interactions for controlling operations of the computing device 400. The input devices may include, but are not limited to, physical and/or touch keyboard 450. The input devices can be connected to computing device 400 via a wired and/or wireless connection (e.g., a Bluetooth® connection). The output devices may include, but are not limited to, speaker 452, display 454, and/or light emitting diodes 456. System interface 460 is configured to facilitate wired and/or wireless communications to and from external devices (e.g., network nodes such as access points, etc.).

At least some of hardware entities 414 may perform actions involving access to and use of memory 412, which can be a Random Access Memory (“RAM”), a disk drive, flash memory, a Compact Disc Read Only Memory (“CD-ROM”) and/or another hardware device that is capable of storing instructions and data. Hardware entities 414 can include disk drive unit 416 comprising computer-readable storage medium 418 on which is stored one or more sets of instructions 420 (e.g., software code) configured to implement one or more of the methodologies, procedures, or functions described herein. Instructions 420, applications 424, and/or parameters 426 can also reside, completely or at least partially, within memory 412 and/or within CPU 406 during execution and/or use thereof by computing device 400. Memory 412 and CPU 406 may include machine-readable media. The term “machine-readable media”, as used here, may refer to a single medium or multiple media (e.g., a centralized or distributed database, and/or associated caches and server) that store the one or more sets of instructions 420. The term “machine readable media”, as used here, may refer to any medium that is capable of storing, encoding or carrying a set of instructions 420 for execution by computing device 400 and that cause computing device 400 to perform any one or more of the methodologies of the present disclosure.

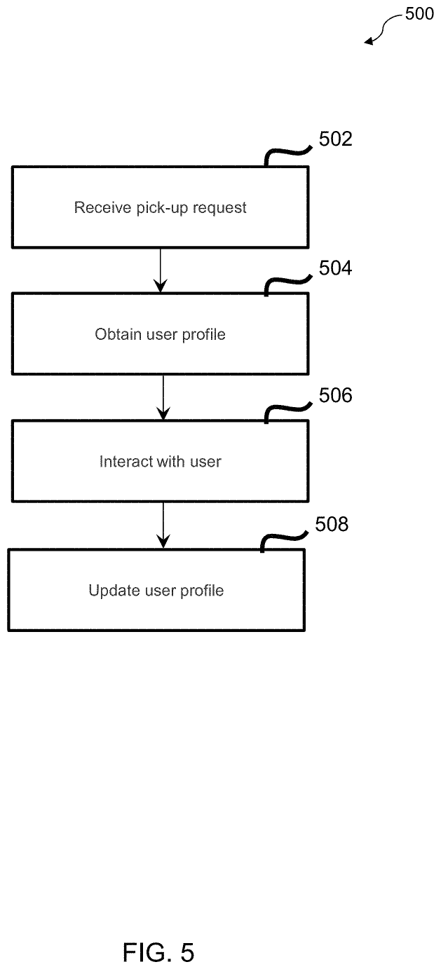

Referring now to FIG. 5, FIG. 5 is a flowchart of non-limiting embodiments or aspects of a process 500 for mutual discovery between passengers and autonomous vehicles. In some non-limiting embodiments or aspects, one or more of the steps of process 500 may be performed (e.g., completely, partially, etc.) by autonomous vehicle 102 (e.g., system architecture 200, etc.). In some non-limiting embodiments or aspects, one or more of the steps of process 500 may be performed (e.g., completely, partially, etc.) by another device or a group of devices separate from or including autonomous vehicle 102 (e.g., system architecture 200, etc.), such as service system 104 (e.g., one or more devices of service system 104, etc.) and/or user device 108 (e.g., one or more devices of a system of user device 108, etc.).

As shown in FIG. 5, at step 502, process 500 includes receiving a pick-up request. For example, autonomous vehicle 102 (e.g., system architecture 200, etc.) may receive a pick-up request to pick-up a user with autonomous vehicle 102. As an example, autonomous vehicle 102 (e.g., system architecture 200, etc.) may receive, from user device 108 (e.g., via service system 104 and/or communication network 106, etc.) a pick-up request to pick-up a user with autonomous vehicle 102.

A pick-up request may include a pick-up location (e.g., a geographic location, an address, a latitude and a longitude, etc.) at which a user requests to be picked up by autonomous vehicle 102 and/or a user identifier associated with the user (e.g., a user account identifier, etc.).

As shown in FIG. 5, at step 504, process 500 includes obtaining a user profile associated with a user. For example, autonomous vehicle 102 (e.g., system architecture 200, etc.) may obtain a user profile associated with the user. As an example, autonomous vehicle 102 (e.g., system architecture 200, etc.) may retrieve, from a database (e.g., a database associated with service system 104, etc.), a user profile stored in association with the user identifier associated with the user from which the pick-up request is received.

Autonomous vehicle 102 (e.g., system architecture 200, etc.) and/or service system 104 may collect information used in generating and/or maintaining a user profile from one or more application platforms, such as a ride sharing application platform, or directly from a user. For example, a user may provide user input data into user device 112 to provide information to be stored within a user profile. As an example, autonomous vehicle 102 (e.g., system architecture 200, etc.) and/or service system 104 may generate a user profile for a user and the user profile may be associated with the user identifier for the application platform, such as the ride sharing application platform, and/or the like. In such an example, autonomous vehicle 102 (e.g., system architecture 200, etc.) and/or service system 104 may store a plurality of user profiles associated with a plurality of user identifiers associated with a plurality of users.

A user profile may include one or more user preferences associated with a user. For example, a user preference may include user preferences for settings and/or operations of an autonomous vehicle providing services to the user. As an example, a user profile may include a data structure including names, types, and/or categories of each user preference stored for a user, the setting indications for each user preference, and, in some non-limiting embodiments or aspects, one or more conditions associated with a user preference. In such an example, for each user preference stored for a user, a user profile may include one or more indications of a preference or setting of the user. For example, a user profile may include a preference or setting for one or more of the following user preferences: a voice type preference for a virtual driver (e.g., character, tone, volume, etc.), a personality type preference of a virtual driver, an appearance type preference of a virtual driver, a location threshold preference for unlocking a door of an autonomous vehicle, a music settings/entertainment preference (e.g., quiet mode, music, news, or the like), an environment preference (e.g., temperature, lighting, scents, etc.), driving style (e.g., aggressive, passive, etc.), a driving characteristic preference (e.g., braking, acceleration, turning, lane changes, avoid left lane, etc.), an autonomous vehicle comfort level preference, a route type preference (e.g., highway versus local streets versus backroads, specific streets to use or avoid, etc.), a favored/disfavored routes preference, a stops made during trips preference (for example, restaurants, stores, sites, etc.), a driving mode preference (e.g., fastest possible, slow routes, etc.), a travel mode preference (e.g., tourist, scenic, business, etc.), a vehicle settings preference (e.g., seat position, etc.), a vehicle preference, or any combination thereof. A condition associated with a user preference may include a day and/or a time of day information, such as preferences associated with a work commute versus social trips, weekday preferences versus weekend preferences, and/or the like, and/or seasonal information/conditions, such as vehicle environment preferences during winter versus vehicle environment preferences during summer, and/or the like. In such an example, autonomous vehicle 102 (e.g., system architecture 200, etc.) may use user preferences in the determination of the behavior or operation of autonomous vehicle 102, for example, by adjusting factor weights in decision processes and/or by disfavoring or disallowing (and/or favoring or enabling) certain types of vehicle behaviors or operations (e.g., as indicated in a determination/weight adjustment field, for example).

Autonomous vehicle 102 (e.g., system architecture 200, etc.) and/or service system 104 may map one or more user profile preferences to one or more operations of autonomous vehicle 102. For example, autonomous vehicle 102 (e.g., system architecture 200, etc.) and/or service system 104 may store, in a database, user preference data that includes indications of autonomous vehicle operations that can be affected or modified based on user profile preferences. In such an example, user preferences can be translated into parameters that can be used by autonomous vehicle 102 (e.g., system architecture 200, etc.) for implementing such operations.

In some non-limiting embodiments or aspects, autonomous vehicle 102 (e.g., system architecture 200, etc.) and/or service system 104 may use one or more machine learning models to generate a user profile for a user. For example, autonomous vehicle 102 (e.g., system architecture 200, etc.) and/or service system 104 may use a machine learning model to populate default settings for user preferences in a user profile and/or to determine settings for user preferences when the settings are not provided by the user. As an example, autonomous vehicle 102 (e.g., system architecture 200, etc.) and/or service system 104 may generate a model (e.g., an estimator, a classifier, a prediction model, a detector model, etc.) using machine learning techniques including, for example, supervised and/or unsupervised techniques, such as decision trees (e.g., gradient boosted decision trees, random forests, etc.), logistic regressions, artificial neural networks (e.g., convolutional neural networks, etc.), Bayesian statistics, learning automata, Hidden Markov Modeling, linear classifiers, quadratic classifiers, association rule learning, and/or the like. The machine learning model may be trained to provide an output including a predicted setting for a user preference of a user in response to input including one or more attributes associated with the user (e.g., age, weight, gender, other demographic information, user input data associated with one or more previous interactions with the user as described herein in more detail below, etc.) and/or one or more known user preferences of the user. For example, autonomous vehicle 102 (e.g., system architecture 200, etc.) and/or service system 104 may train the model based on training data associated with one or more attributes associated with one or more users and/or one or more user preferences associated with the one or more users. In such an example, autonomous vehicle 102 (e.g., system architecture 200, etc.) and/or service system 104 may store the model (e.g., store the model for later use), for example, in a data structure (e.g., a database, a linked list, a tree, etc.).

As shown in FIG. 5, at step 506, process 500 includes interacting with a user. For example, autonomous vehicle 102 (e.g., system architecture 200, etc.) may interact with the user. As an example, autonomous vehicle 102 (e.g., system architecture 200, etc.) may interact with the user via user device 108 and/or via one or more input devices and/or one or more output devices (e.g., via display 454, speaker 452, light emitting diodes 456, etc.) of autonomous vehicle 102.

In some non-limiting embodiments or aspects, autonomous vehicle 102 (e.g., system architecture 200, etc.) may provide a virtual driver or avatar that interacts with the user via user device 108 and/or via the one or more input devices and/or the one or more output devices of autonomous vehicle 102. For example, user device 108 and/or the one or more output devices of autonomous vehicle 102 may provide, via an audio and/or visual representation of a virtual driver, audio and/or visual information and/or data to the user from autonomous vehicle 102 (e.g., system architecture 200, etc.) and/or user device 108 and/or the one or more input devices of autonomous vehicle 102 may receive user input data from the user and provide the user input data to autonomous vehicle 102 (e.g., system architecture 200, etc.). As an example, one or more machine learning systems (e.g., artificial intelligence systems, etc.) may be used to provide the virtual driver. In such an example, machine learning systems may provide for more intelligent interaction with the user via user device 108 and/or via the one or more input devices and/or the one or more output devices of autonomous vehicle 102.

Autonomous vehicle 102 (e.g., system architecture 200, etc.) may interact with a user by receiving user input data. For example, autonomous vehicle 102 (e.g., system architecture 200, etc.) may receive, from user device 108 associated with the user, user input data associated with a user request and/or response to autonomous vehicle 102. As an example, user input data may be associated with one or more user preferences and/or one or more operations of autonomous vehicle 102. In such an example, user input data may include a request that autonomous vehicle 102 perform an operation and/or perform an operation according to a user preference of the user (e.g., according to a user preference not included in a user profile of a user, according to a user preference different than a user preference included in a user profile of a user, according to a confirmation of a user preference included in a user profile of a user, etc.). For example a request to autonomous vehicle 102 may include a request to perform at least one of the following operations: answering a question included in the request (e.g., Can you see me?, How far away are you?, When will you be here?, etc.), unlocking a door of autonomous vehicle, moving autonomous vehicle 102 closer to the user, waiting for the user at a user requested location, calling the police (e.g., autonomous vehicle 102 may provide audio output via an external speaker to inform persons outside autonomous vehicle 102 that they are being recorded on camera and that the police have been called while turning on bright lights, etc.), flashing lights and/or an RGB tiara ring of autonomous vehicle 102, playing an audio clip from a speaker of autonomous vehicle 102, providing a video feed from an external camera of autonomous vehicle 102 to user device 108 such that the user may view an area currently surrounding autonomous vehicle 102 to confirm a current location and/or identity of autonomous vehicle 102, providing a video feed from an internal camera of autonomous vehicle 102 to user device 108 such that the user may view the interior of autonomous vehicle 102 to confirm that autonomous vehicle 102 is empty before the user enters autonomous vehicle 102, unlocking a specific door of autonomous vehicle 102 indicated by the user (while keeping the remaining doors locked), immediately locking a door of autonomous vehicle 102 upon closing of the door, and/or the like. In such an example, user input data may include a response to a prompt or question from autonomous vehicle 102, such as a yes/no response to a prompt or question from autonomous vehicle 102, a description of a location (e.g., an address, a landmark, etc.), and/or the like.

In some non-limiting embodiments or aspects, user input data may include audio data associated with an audio signal. For example, autonomous vehicle 102 (e.g., system architecture 200, etc.) and/or user device 108 may process user input data using one or more natural language processing (NLP) techniques to determine a user request and/or response to autonomous vehicle 102. As an example, user device 108 and/or autonomous vehicle 102 may capture, using a microphone, a user request and/or response to autonomous vehicle 102 spoken by a user, and autonomous vehicle 102 (e.g., system architecture 200, etc.) and/or user device 108 may process user input data associated with the captured audio to determine the user request and/or response to autonomous vehicle 102.

In some non-limiting embodiments or aspects, user input data may include image data associated with an image signal. For example, autonomous vehicle 102 (e.g., system architecture 200, etc.) and/or user device 108 may process user input data using one or more lip reading techniques and a user request and/or response to autonomous vehicle 102. As an example, user device 108 and/or autonomous vehicle 102 may capture, using an image capture device (e.g., a camera, etc.), a user request and/or response to autonomous vehicle 102, spoken and/or signed by a user in a series of images, and autonomous vehicle 102 (e.g., system architecture 200, etc.) and/or user device 108 may process user input data associated with the captured series of images to determine the user request and/or response to autonomous vehicle 102.

In some non-limiting embodiments or aspects, a question or prompt from autonomous vehicle 102 may include questions or prompts, such as “Can you wave to me down the street?”, “Can you see me through user device 108?”, “Are you OK with paying a surcharge to wait?”, “Can I leave now and have another autonomous vehicle pick you up in about 10 minutes?”, and/or the like.

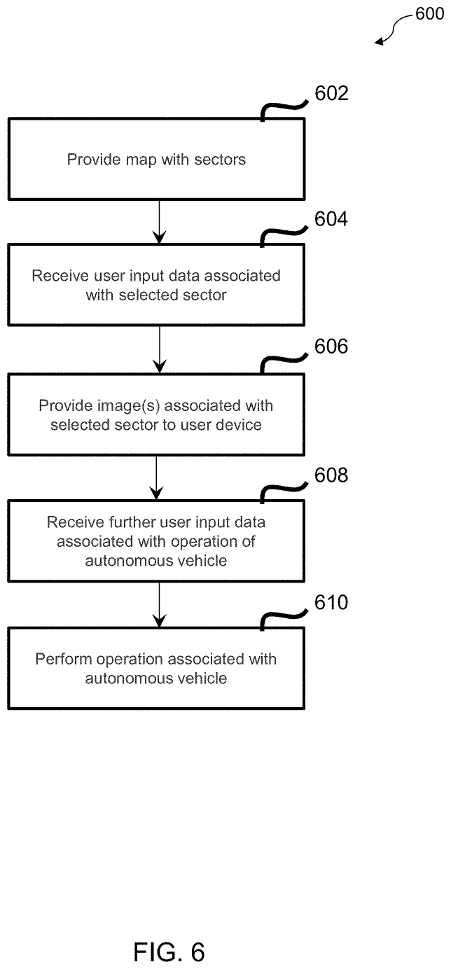

Further details regarding non-limiting embodiments or aspects of step 506 of process 500 are provided below with regard to FIGS. 6-8.

As shown in FIG. 5, at step 508, process 500 includes updating a user profile. For example, autonomous vehicle 102 (e.g., system architecture 200, etc.) may update a user profile. As an example, autonomous vehicle 102 (e.g., system architecture 200, etc.) and/or service system 104 may update, based on one or more interactions with the user (e.g., based the user input data, etc.), the user profile associated with the user. In such an example, autonomous vehicle 102 (e.g., system architecture 200, etc.) and/or service system 104 may use one or more machine learning models to update the user profile for the user. For example, autonomous vehicle 102 (e.g., system architecture 200, etc.) and/or service system 104 may generate a model (e.g., an estimator, a classifier, a prediction model, a detector model, etc.) using machine learning techniques including, for example, supervised and/or unsupervised techniques, such as decision trees (e.g., gradient boosted decision trees, random forests, etc.), logistic regressions, artificial neural networks (e.g., convolutional neural networks, etc.), Bayesian statistics, learning automata, Hidden Markov Modeling, linear classifiers, quadratic classifiers, association rule learning, and/or the like. The machine learning model may be trained to provide an output including a predicted setting (e.g., an updated setting, etc.) for a user preference of a user in response to input including user input data (e.g., one or more user requests and/or responses to autonomous vehicle 102, etc.), one or more attributes associated with the user (e.g., age, weight, gender, other demographic information, user input data associated with one or more previous interactions with the user as describe herein in more detail below, etc.), and/or one or more existing user preferences of the user. For example, autonomous vehicle 102 (e.g., system architecture 200, etc.) and/or service system 104 may train the model based on training data associated with one or more user requests and/or responses associated with one or more users, one or more attributes associated with one or more users, and/or one or more user preferences associated with the one or more users. In such an example, autonomous vehicle 102 (e.g., system architecture 200, etc.) and/or service system 104 may store the model (e.g., store the model for later use), for example, in a data structure (e.g., a database, a linked list, a tree, etc.).

Referring now to FIG. 6, FIG. 6 is a flowchart of non-limiting embodiments or aspects of a process 600 for mutual discovery between passengers and autonomous vehicles. In some non-limiting embodiments or aspects, one or more of the steps of process 600 may be performed (e.g., completely, partially, etc.) by autonomous vehicle 102 (e.g., system architecture 200, etc.). In some non-limiting embodiments or aspects, one or more of the steps of process 600 may be performed (e.g., completely, partially, etc.) by another device or a group of devices separate from or including autonomous vehicle 102 (e.g., system architecture 200, etc.), such as service system 104 (e.g., one or more devices of service system 104, etc.) and/or user device 108 (e.g., one or more devices of a system of user device 108, etc.).

As shown in FIG. 6, at step 602, process 600 includes providing a map including a plurality of sectors. For example, autonomous vehicle 102 (e.g., system architecture 200, etc.) may provide a map including a plurality of sectors. As an example, autonomous vehicle 102 (e.g., system architecture 200, etc.) may provide (e.g., in response to receiving a pick-up request to pick-up a user, etc.), to a user device associated with the user, a map of a geographic location in which the autonomous vehicle 102 is currently located. In such an example, the map may include a plurality of sectors corresponding to a plurality of fields of view of a plurality of image capture devices of the autonomous vehicle.

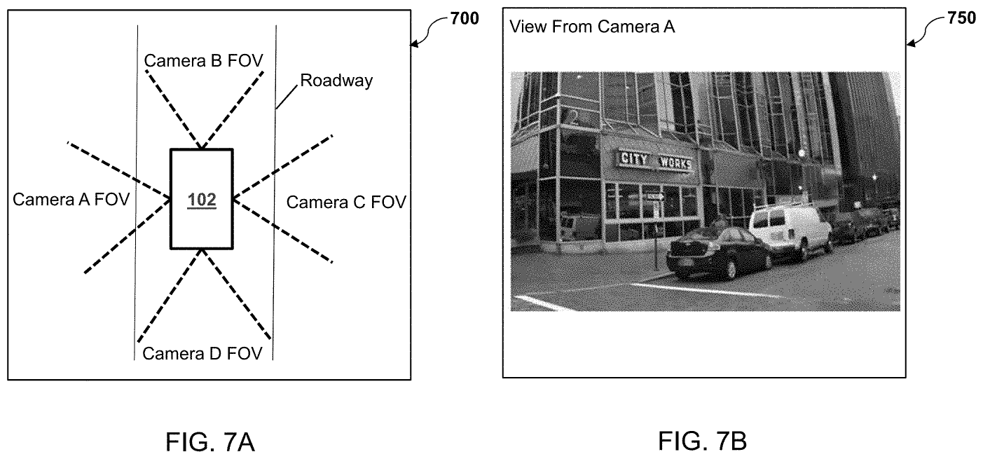

Referring also to FIG. 7A, FIG. 7A is an illustration of non-limiting embodiments or aspects of a map 700 including sectors corresponding to fields of view of image capture devices of an autonomous vehicle. For example, autonomous vehicle 102 (e.g., system architecture 200, etc.) may include a plurality of image capture devices (e.g., cameras, etc.) configured to capture a plurality of fields of view of the environment surrounding autonomous vehicle 102. As an example, autonomous vehicle 102 (e.g., system architecture 200, etc.) may provide (e.g., communicate, etc.), to user device 108, the map 700 including a representation of a current or real-time location of autonomous vehicle 102 within the geographic location represented by the map and representations of a plurality of sectors (e.g., Camera A FOV, Camera B FOV, Camera C FOV, Camera D FOV, etc.) that correspond to the plurality of fields of view of the plurality of cameras of autonomous vehicle 102. In such an example, the user may view the map 700 on user device 108, for example, to determine a current location of autonomous vehicle 102 and/or to select a sector to see a view from an image capture device of autonomous vehicle 102 for that sector.

As shown in FIG. 6, at step 604, process 600 includes receiving user input data associated with a selected sector. For example, autonomous vehicle 102 (e.g., system architecture 200, etc.) may receive user input data associated with a selected sector. As an example, autonomous vehicle 102 (e.g., system architecture 200, etc.) may receive, from user device 108, user input data associated with a selection of a sector of the plurality of sectors in the map. In such an example, and referring again to FIG. 7A, the user may view the map 700 on user device 108, and user device 108 may provide (e.g., communicate, etc.) to autonomous vehicle 102, a sector selected by the user on user device 108.

In some non-limiting embodiments or aspects, the user input data associated with selection of the sector of the plurality of sectors may include an audio signal, and autonomous vehicle 102 (e.g., system architecture 200, etc.) and/or user device 108 may apply a NLP technique or software to the audio signal to determine the selection of the sector of the plurality of sectors. For example, the user may speak “Show me the Sector for Camera A” and/or the like into user device 108, which captures the audio signal, and autonomous vehicle 102 (e.g., system architecture 200, etc.) and/or user device 108 may apply the NLP technique or software to the audio signal to determine the sector selected by the user.

As shown in FIG. 6, at step 606, process 600 includes providing one or more images associated with a selected sector to a user device. For example, autonomous vehicle 102 (e.g., system architecture 200, etc.) may provide one or more images associated with a selected sector to a user device. As an example, autonomous vehicle 102 (e.g., system architecture 200, etc.) may, in response to receiving the user input data associated with the selection of the sector of the plurality of sectors from user device 108, provide (e.g., communicate, etc.), to user device 108, one or more images from an image capture device of the plurality of image capture devices corresponding to the selected sector of the plurality of sectors. In such an example, the one or more images may include a live or real-time feed of the field of view of the camera corresponding to the selected sector.

Referring also to FIG. 7B, FIG. 7B is an illustration of non-limiting embodiments or aspects of a view 750 from an image capture device. For example, as shown in FIG. 7B, in response to receiving user input data associated with a selection of the sector labeled “Camera A FOV” in FIG. 7A from user device 108, autonomous vehicle 102 (e.g., system architecture 200, etc.) may provide, to user device 108, one or more images (e.g., a live video feed, etc.) from Camera A of autonomous vehicle 102. As an example, by selecting a sector corresponding to a perspective around autonomous vehicle 102, a view from autonomous vehicle 102 of the selected sector may be displayed to the user on user device 108. In such an example, being able to watch autonomous vehicle 102 travel on roads that may be familiar to the user may give the user confidence that autonomous vehicle 102 is on the way, provide insight as to traffic, and/or provide a more immersive and calming experience than looking only at a map.

As shown in FIG. 6, at step 608, process 600 includes receiving further user input data associated with an operation of an autonomous vehicle. For example, autonomous vehicle 102 (e.g., system architecture 200, etc.) may receive further user input data associated with an operation of an autonomous vehicle. As an example, autonomous vehicle 102 (e.g., system architecture 200, etc.) may receive, from user device 108, further user input data associated with an operation of autonomous vehicle 102.

In some non-limiting embodiments or aspects, the further user input data may include an audio signal, and autonomous vehicle 102 (e.g., system architecture 200, etc.) and/or user device 108 may apply the NLP technique or software to the audio signal to determine a request from the user associated with an operation of autonomous vehicle 102.

In some non-limiting embodiments or aspects, autonomous vehicle 102 (e.g., system architecture 200, etc.) may receive, from user device 108, further user input data associated with a request to view an interior of autonomous vehicle 102. For example, the user may wish to confirm that the interior of autonomous vehicle 102 is empty (e.g., free of other passengers, etc.) before entering autonomous vehicle.

In some non-limiting embodiments or aspects, autonomous vehicle 102 (e.g., system architecture 200, etc.) may receive, from user device 108, further user input data associated with a request to provide an audio and/or visual output from an audio and/or visual output device of autonomous vehicle 102, such as a request that autonomous vehicle 102 flash headlights and/or an RGB tiara ring of autonomous vehicle 102, play an audio clip from an external speaker of autonomous vehicle 102, provide a video feed from an external camera of autonomous vehicle 102 to user device 108 such that the user may view an area currently surrounding autonomous vehicle 102 to confirm a current location and/or identity of autonomous vehicle 102, and/or the like.

In some non-limiting embodiments or aspects, autonomous vehicle 102 (e.g., system architecture 200, etc.) may receive, from user device 108, further user input data associated with an identification of an area in the one or more images from the image capture device of the plurality of image capture devices corresponding to the selected sector of the plurality of sectors. For example, the user may identify, in the one or more images on user device 108 (e.g., by touching a touchscreen display of user device 108, etc.), an area in the one or more images at which the user desires to be picked-up (e.g., a new pick-up location, an updated pick-up location, etc.).

In some non-limiting embodiments or aspects, autonomous vehicle 102 (e.g., system architecture 200, etc.) may receive, from user device 108, further user input data associated with an identification of the user in the one or more images. For example, the user may recognize themselves in the live or real-time feed of the field of view of the camera corresponding to the selected sector, and the user may help autonomous vehicle 102 to locate and/or identify the user by identifying themselves within the images.

As shown in FIG. 6, at step 610, process 600 includes controlling an autonomous vehicle to perform an operation. For example, autonomous vehicle 102 (e.g., system architecture 200, etc.) may control autonomous vehicle 102 to perform an operation. As an example, autonomous vehicle 102 (e.g., system architecture 200, etc.) may control autonomous vehicle 102 to perform an operation associated with user input data (e.g., further user input data, etc.) received from user device 108.

In some non-limiting embodiments or aspects, autonomous vehicle 102 (e.g., system architecture 200, etc.) may, in response to receiving the request to view the interior of autonomous vehicle 102, provide, to user device 108, one or more images of an interior of autonomous vehicle 102. As an example, autonomous vehicle 102 may include one or more internal image capture devices configured to capture one or more images (e.g., a live video feed, etc.) of the interior (e.g., a seating area, etc.) of autonomous vehicle 102.

In some non-limiting embodiments or aspects, autonomous vehicle 102 (e.g., system architecture 200, etc.) may, in response to receiving the request to provide the audio and/or visual output, control the audio and/or visual output device of autonomous vehicle 102 to provide the audio and/or visual output. As an example, autonomous vehicle 102 may include one or more external audio and/or visual output devices (e.g., lights, displays, speakers, an RGB tiara ring, etc.) configured to provide audio and/or visual output to the environment surrounding autonomous vehicle 102.

In some non-limiting embodiments or aspects, autonomous vehicle 102 (e.g., system architecture 200, etc.) may, in response to receiving the identification of the area in the one or more images, set a geographic location associated with the identified area as a pick-up location for picking-up the user with the autonomous vehicle. For example, autonomous vehicle 102 (e.g., system architecture 200, etc.) may use one or more image processing techniques to identify the geographic location associated with the identified area, and set the identified geographic location as a pick-up location for picking-up the user.

In some non-limiting embodiments or aspects, autonomous vehicle 102 (e.g., system architecture 200, etc.) may determine, based on the further user input data associated with an identification of the user in the one or more images (e.g., based on the identified user, etc.), a location of the user in the environment surrounding the autonomous vehicle. For example, autonomous vehicle 102 (e.g., system architecture 200, etc.) may use one or more image processing techniques to identify the geographic location associated with the identified user, and set the identified geographic location as the current location of the user.

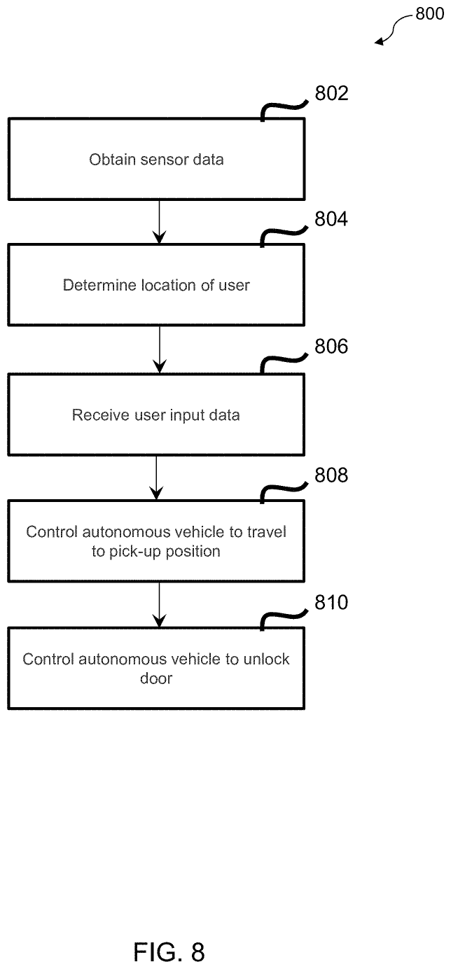

Referring now to FIG. 8, FIG. 8 is a flowchart of non-limiting embodiments or aspects of a process 800 for mutual discovery between passengers and autonomous vehicles. In some non-limiting embodiments or aspects, one or more of the steps of process 800 may be performed (e.g., completely, partially, etc.) by autonomous vehicle 102 (e.g., system architecture 200, etc.). In some non-limiting embodiments or aspects, one or more of the steps of process 800 may be performed (e.g., completely, partially, etc.) by another device or a group of devices separate from or including autonomous vehicle 102 (e.g., system architecture 200, etc.), such as service system 104 (e.g., one or more devices of service system 104, etc.) and/or user device 108 (e.g., one or more devices of a system of user device 108, etc.).

As shown in FIG. 8, at step 802, process 800 includes obtaining sensor data. For example, autonomous vehicle 102 (e.g., system architecture 200, etc.) may obtain sensor data. As an example, autonomous vehicle 102 (e.g., system architecture 200, etc.) may obtain sensor data associated with an environment surrounding autonomous vehicle 102 and/or an interior of autonomous vehicle 102. As an example, sensor data may include information and/or data from one or more of the sensors included in system architecture 200, such as camera(s) 262, LiDAR sensor system 264, Radar/Sonar 266, one or more exterior cameras configured to capture images of an exterior of autonomous vehicle 102, one or more interior cameras configured to capture images of an interior of autonomous vehicle 102, one or more exterior microphones configured to capture audio in the environment surrounding autonomous vehicle 102, one or more interior microphones configured to capture audio in the interior of autonomous vehicle 102 , and/or the like. For example, the one or more sensors 204 can be used to collect sensor data that includes information that describes the location (e.g., in three-dimensional space relative to autonomous vehicle 102, etc.) of points that correspond to objects (e.g., the user, etc.) within the surrounding environment of autonomous vehicle 102.

In some non-limiting embodiments or aspects, sensor data may include user input data. For example, autonomous vehicle 102 (e.g., system architecture 200, etc.) may receive, directly from the one or more sensors included in system architecture 200 (e.g., instead of from user device 108, etc.), user input data associated with a user preference, request, and/or response to autonomous vehicle 102. In some non-limiting embodiments or aspects, sensor data may include map data that defines one or more attributes of (e.g., metadata associated with) a roadway (e.g., attributes of a roadway in a geographic location, attributes of a segment of a roadway, attributes of a lane of a roadway, attributes of an edge of a roadway, attributes of a driving path of a roadway, etc.). In some non-limiting embodiments or aspects, an attribute of a roadway includes a road edge of a road (e.g., a location of a road edge of a road, a distance of location from a road edge of a road, an indication whether a location is within a road edge of a road, etc.), an intersection, connection, or link of a road with another road, a roadway of a road, a distance of a roadway from another roadway (e.g., a distance of an end of a lane and/or a roadway segment or extent to an end of another lane and/or an end of another roadway segment or extent, etc.), a lane of a roadway of a road (e.g., a travel lane of a roadway, a parking lane of a roadway, a turning lane of a roadway, lane markings, a direction of travel in a lane of a roadway, etc.), a centerline of a roadway (e.g., an indication of a centerline path in at least one lane of the roadway for controlling autonomous vehicle 102 during operation (e.g., following, traveling, traversing, routing, etc.) on a driving path, a driving path of a roadway (e.g., one or more trajectories that autonomous vehicle 102 can traverse in the roadway and an indication of the location of at least one feature in the roadway a lateral distance from the driving path, etc.), one or more objects (e.g., a vehicle, vegetation, a pedestrian, a structure, a building, a sign, a lamppost, signage, a traffic sign, a bicycle, a railway track, a hazardous object, etc.) in proximity to and/or within a road (e.g., objects in proximity to the road edges of a road and/or within the road edges of a road), a sidewalk of a road, and/or the like.

As shown in FIG. 8, at step 804, process 800 includes determining a location of a user. For example, autonomous vehicle 102 (e.g., system architecture 200, etc.) may determine a location of a user. As an example, autonomous vehicle 102 (e.g., system architecture 200, etc.) may determine, based on the sensor data, the user input data, and/or the map data, a location of a user. In such an example, autonomous vehicle 102 (e.g., system architecture 200, etc.) may determine, based on the sensor data, the user input data, and/or the map data, using one or more object recognition techniques, one or more pose estimation techniques, one or more motion prediction techniques, and/or the like, a location of the user in three-dimensional space relative to autonomous vehicle 102 and/or one or more other objects within the environment surrounding autonomous vehicle 102. In some non-limiting embodiments or aspects, at least a portion of the processing of sensor data (and/or user input data) (e.g., image processing, NLP processing, etc.) may be performed on user device 108 (e.g., via the rideshare application, etc.) and/or at service system 104 before providing the results and/or data to autonomous vehicle 102 (e.g., system architecture 200, etc.).

In some non-limiting embodiments or aspects, sensor data may include image data associated with one or more images of the environment surrounding the autonomous vehicle 102 (e.g., camera images, LiDAR images, etc.), and autonomous vehicle 102 (e.g., system architecture 200, etc.) may determine a location of the user by applying an object recognition technique to the one or more images.

In some non-limiting embodiments or aspects, autonomous vehicle 102 (e.g., system architecture 200, etc.) may include a plurality of phased array antennas. For example, autonomous vehicle 102 (e.g., system architecture 200, etc.) may receive, using the plurality of phased array antennas, a Bluetooth® signal from user device 108 associated with the user, and autonomous vehicle 102 (e.g., system architecture 200, etc.) may determine the location of the user by applying a Bluetooth® Direction Finding technique to the Bluetooth® signal. In such an example, the Bluetooth® signal may include a request for autonomous vehicle 102 to confirm that autonomous vehicle 102 is authentic, and autonomous vehicle 102 (e.g., system architecture 200, etc.) may, in response to receiving the Bluetooth® signal including the request, transmit, via another Bluetooth® signal, to user device 108, a confirmation that autonomous vehicle 102 is authentic (e.g., the same autonomous vehicle assigned by the rideshare application to pick-up the user, etc.). For example, the rideshare application on user device 108 may use challenge/response communications to ensure that autonomous vehicle 102 is legitimately sent by the rideshare application and is not an imposter. As an example, the user may receive a message such as “Your AV is authentic” and/or the like on user device 108 in response to autonomous vehicle 102 providing a correct response to the challenge from user device 108, and the user may receive an alert and/or the like on user device 108 in response to autonomous vehicle 102 failing to provide a correct response to the challenge.

In some non-limiting embodiments or aspects, autonomous vehicle 102 (e.g., system architecture 200, etc.) may capture a pattern displayed by user device 108 to determine the location of the user. For example, a user may hold up user device 108 to face autonomous vehicle 102, and user device 108 may display a unique pattern (e.g., a video of changing colors, etc.), and autonomous vehicle 102 (e.g., system architecture 200, etc.) may capture the pattern displayed by user device 108 to determine the location of the user. In such an example, a camera of user device 108 may captured one or more images of autonomous vehicle 102 and provide the capture images to autonomous vehicle 102, and autonomous vehicle 102 (e.g., system architecture 200, etc.) may use the one or more images to determine a location of autonomous vehicle 102 relative to the user. As an example, the user may hold user device 108 above their head in a situation where there may be people between the user and autonomous vehicle 102, which may enable autonomous vehicle 102 to more easily locate and identify the customer in a crowd of people.

As shown in FIG. 8, at step 806, process 800 includes receiving user input data. For example, autonomous vehicle 102 (e.g., system architecture 200, etc.) may receive user input data. As an example, autonomous vehicle 102 (e.g., system architecture 200, etc.) may receive, from user device 108 and/or one more user input devices of autonomous vehicle 102, user input data.

In some non-limiting embodiments or aspects, autonomous vehicle 102 (e.g., system architecture 200, etc.) may receive, from user device 108, user input data associated with an image of an environment surrounding the user, the image being associated with a geographic location (e.g., GPS coordinates, etc.) of the user device at a time the image is captured. For example, autonomous vehicle 102 (e.g., system architecture 200, etc.) may apply an object recognition technique to the image to identify one or more objects in the image, the one or more objects in the image being associated with one or more predetermined geographic locations (e.g., landmarks, etc.), and autonomous vehicle 102 (e.g., system architecture 200, etc.) may determine the location of the user based on the sensor data, the one or more predetermined geographic locations of the one or more objects identified in the image, and/or the geographic location of user device 108. As an example, autonomous vehicle 102 (e.g., system architecture 200, etc.) and/or service system 104 may examine one or more images from a user to determine the location of the user, such as by locating autonomous vehicle 102 and/or other reference objects on a map and performing triangulation to estimate the location of the user.

In some non-limiting embodiments or aspects, autonomous vehicle 102 (e.g., system architecture 200, etc.) may receive, from user device 108, user input data associated with an image of the user, and the object recognition technique may use the image of the user to identify the user in the one or more images of the environment surrounding the autonomous vehicle 102. For example, the user may take a “selfie” image with user device 108 and provide the selfie to autonomous vehicle 102 (e.g., system architecture 200, etc.) and/or service system 104 via the application. The “selfie” image may reveal clothing of the user, objects proximate the user (e.g., luggage, etc.) and/or other features of the user (e.g., facial features, etc.) that autonomous vehicle 102 (e.g., system architecture 200, etc.) may use to help identify the user (e.g., from among various other persons, etc.) and/or to detect a fraud case where someone is attempting to impersonate the user.

In some non-limiting embodiments or aspects, user input data may include audio data associated with an audio signal. For example, autonomous vehicle 102 (e.g., system architecture 200, etc.) and/or user device 108 may process user input data using one or more natural language processing (NLP) techniques to determine a user request and/or response to autonomous vehicle 102. As an example, user device 108 and/or autonomous vehicle 102 may capture, using a microphone, a user request and/or response to autonomous vehicle 102 spoken by a user, and autonomous vehicle 102 (e.g., system architecture 200, etc.) and/or user device 108 may process user input data associated with the captured audio to determine the user request and/or response to autonomous vehicle 102. In such an example, the user input data may be associated with an operation of autonomous vehicle 102 requested by the user, and autonomous vehicle 102 (e.g., system architecture 200, etc.) may apply the NLP technique to the audio signal in the user input data to determine the operation and/or control autonomous vehicle 102 to perform the operation.

As shown in FIG. 8, at step 808, process 800 includes controlling an autonomous vehicle to travel to a pick-up position. For example, autonomous vehicle 102 (e.g., system architecture 200, etc.) may control autonomous vehicle 102 to travel to a pick-up position. As an example, autonomous vehicle 102 (e.g., system architecture 200, etc.) may control autonomous vehicle 102 to travel to a pick-up position (e.g., a geographic position or location, a map location, etc.) for picking-up the user. In such an example, autonomous vehicle 102 (e.g., system architecture 200, etc. may determine the pick-up position based on the location of the user. For example, the pick-up position may be included in the pick-up request, set by a user preference, set by the user via user input data, and/or set by autonomous vehicle 102 based on sensor data, user input data, and/or map data.

In some non-limiting embodiments or aspects, autonomous vehicle 102 (e.g., system architecture 200, etc.) may control autonomous vehicle 102 to travel to the pick-up position by providing, to user device 108, a prompt for the user to travel to the pick-up position. For example, the prompt may include directions for walking to the pick-up position. As an example, the directions for walking to the pick-up position may include an augmented reality overlay. In such an example, user device 108 may display the augmented reality overlay including an augmented representation of autonomous vehicle 102 (e.g., a pulsating aura around autonomous vehicle 102, etc.) and inform the user that autonomous vehicle 102 has arrived.

As shown in FIG. 8, at step 810, process 800 includes controlling an autonomous vehicle to unlock a door of the autonomous vehicle. For example, autonomous vehicle 102 (e.g., system architecture 200, etc.) may control autonomous vehicle 102 to unlock a door of autonomous vehicle 102. As an example, autonomous vehicle 102 (e.g., system architecture 200, etc.) may control, in response to a location of the user satisfying a threshold location with respect to a door of autonomous vehicle 102, the autonomous vehicle 102 to unlock the door. In such an example, the location of the user may be determined based on the sensor data. In such an example, the threshold location with respect to the door of autonomous vehicle 102 may be determined based on the one or more user preferences (e.g., the user profile of the user may include a user preference setting the threshold distance for one or more doors of autonomous vehicle 102, etc.).

In some non-limiting embodiments or aspects, sensor data may include a near field communication (NFC) signal received from user device 108. For example, autonomous vehicle 102 (e.g., system architecture 200, etc.) may receive the NFC signal in response to the user holding user device 108 against an NFC access point on autonomous vehicle 102. As an example, one or more doors of autonomous vehicle 102 may include one or more NFC access points, and autonomous vehicle 102 (e.g., system architecture 200, etc.) may determine the location of the user (e.g., determine a location of the user satisfying a threshold location with respect to a door of autonomous vehicle 102, etc.) and/or unlock a door of autonomous vehicle 102 in response to an NFC access point associated with that door receiving the NFC signal from user device 108.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, a pick-up request to pick-up a user with an autonomous vehicle;
providing, with the at least one processor, to a user device associated with the user, a map of a geographic location in which the autonomous vehicle is currently located, wherein the map includes a plurality of sectors corresponding to a plurality of fields of view of a plurality of image capture devices of the autonomous vehicle;
receiving, with the at least one processor, from the user device, user input data associated with a selection of a sector of the plurality of sectors in the map; and
in response to receiving the user input data associated with the selection of the sector of the plurality of sectors from the user device, providing, with the at least one processor, to the user device, one or more images from an image capture device of the plurality of image capture devices corresponding to the selected sector of the plurality of sectors.

2. The computer-implemented method of claim 1, further comprising:
receiving, with the at least one processor, from the user device, further user input data associated with a request to view an interior of the autonomous vehicle; and
in response to receiving the request to view the interior of the autonomous vehicle, providing, with the at least one processor, to the user device, one or more images of an interior of the autonomous vehicle.

3. The computer-implemented method of claim 1, further comprising:
receiving, with the at least one processor, from the user device, further user input data associated with a request to provide an audio and/or visual output from an audio and/or visual output device of the autonomous vehicle; and
in response to receiving the request to provide the audio and/or visual output, controlling, with the at least one processor, the audio and/or visual output device of the autonomous vehicle to provide the audio and/or visual output.

4. The computer-implemented method of claim 1, further comprising:
receiving, with the at least one processor, from the user device, further user input data associated with an identification of an area in the one or more images; and
in response to receiving the identification of the area in the one or more images, setting, with the at least one processor, a geographic location associated with the identified area as a pick-up position for picking-up the user with the autonomous vehicle.

5. The computer-implemented method of claim 1, wherein the user input data associated with selection of the sector of the plurality of sectors includes an audio signal, and wherein receiving the user input data further includes applying a natural language processing (NLP) technique to the audio signal to determine the selection of the sector of the plurality of sectors.

6. The computer-implemented method of claim 1, further comprising:
receiving, with the at least one processor, from the user device, further user input data associated with an identification of the user in the one or more images; and
determining, with the at least one processor, based on the identified user, a location of the user in an environment surrounding the autonomous vehicle.

7. The computer-implemented method of claim 1, further comprising:
obtaining, with the at least one processor, a user profile associated with the user, wherein the user profile includes one or more user preferences associated with the user; and
updating, based on the user input data, using a machine learning model, at least one user preference of the user profile associated with the user.

8. A system, comprising:
a memory;
at least one processor coupled to the memory and configured to:
receive a pick-up request to pick-up a user with an autonomous vehicle;
provide, to a user device associated with the user, a map of a geographic location in which the autonomous vehicle is currently located, wherein the map includes a plurality of sectors corresponding to a plurality of fields of view of a plurality of image capture devices of the autonomous vehicle;
receive, from the user device, user input data associated with a selection of a sector of the plurality of sectors in the map; and
in response to receiving the user input data associated with the selection of the sector of the plurality of sectors from the user device, provide, to the user device, one or more images from an image capture device of the plurality of image capture devices corresponding to the selected sector of the plurality of sectors.

9. The system of claim 8, wherein the at least one processor is further configured to:
receive, from the user device, further user input data associated with a request to view an interior of the autonomous vehicle; and
in response to receiving the request to view the interior of the autonomous vehicle, provide, to the user device, one or more images of an interior of the autonomous vehicle.

10. The system of claim 8, wherein the at least one processor is further configured to:
receive, from the user device, further user input data associated with a request to provide an audio and/or visual output from an audio and/or visual output device of the autonomous vehicle; and
in response to receiving the request to provide the audio and/or visual output, control, the audio and/or visual output device of the autonomous vehicle to provide the audio and/or visual output.

11. The system of claim 8, wherein the at least one processor is further configured to:
receive, from the user device, further user input data associated with an identification of an area in the one or more images; and
in response to receiving the identification of the area in the one or more images, set, a geographic location associated with the identified area as a pick-up location for picking-up the user with the autonomous vehicle.

12. The system of claim 8, wherein the user input data associated with selection of the sector of the plurality of sectors includes an audio signal, and wherein receiving the user input data further includes applying a natural language processing (NLP) technique to the audio signal to determine the selection of the sector of the plurality of sectors.

13. The system of claim 8, wherein the at least one processor is further configured to:
receive, from the user device, further user input data associated with an identification of the user in the one or more images; and
determine, based on the identified user, a location of the user in an environment surrounding the autonomous vehicle.

14. The system of claim 8, wherein the at least one processor is further configured to:
obtain, a user profile associated with the user, wherein the user profile includes one or more user preferences associated with the user; and
update, using a machine learning model, at least one user preference of the user profile associated with the user.

15. A computer program product comprising at least one non-transitory computer-readable medium including program instructions that, when executed by at least one processor, cause the at least one processor to:
receive a pick-up request to pick-up a user with an autonomous vehicle;
provide, to a user device associated with the user, a map of a geographic location in which the autonomous vehicle is currently located, wherein the map includes a plurality of sectors corresponding to a plurality of fields of view of a plurality of image capture devices of the autonomous vehicle;
receive, from the user device, user input data associated with a selection of a sector of the plurality of sectors in the map; and
in response to receiving the user input data associated with the selection of the sector of the plurality of sectors from the user device, provide, to the user device, one or more images from an image capture device of the plurality of image capture devices corresponding to the selected sector of the plurality of sectors.

16. The computer program product of claim 15, wherein the instructions, when executed by the at least one processor, further cause the at least one processor to:
receive, from the user device, further user input data associated with a request to view an interior of the autonomous vehicle; and
in response to receiving the request to view the interior of the autonomous vehicle, provide, to the user device, one or more images of an interior of the autonomous vehicle.

17. The computer program product of claim 15, wherein the instructions, when executed by the at least one processor, further cause the at least one processor to:
receive, from the user device, further user input data associated with a request to provide an audio and/or visual output from an audio and/or visual output device of the autonomous vehicle; and
in response to receiving the request to provide the audio and/or visual output, control, the audio and/or visual output device of the autonomous vehicle to provide the audio and/or visual output.

18. The computer program product of claim 15, wherein the instructions, when executed by the at least one processor, further cause the at least one processor to:
receive, from the user device, further user input data associated with an identification of an area in the one or more images; and
in response to receiving the identification of the area in the one or more images, set, a geographic location associated with the identified area as a pick-up location for picking-up the user with the autonomous vehicle.

19. The computer program product of claim 15, wherein the user input data associated with selection of the sector of the plurality of sectors includes an audio signal, and wherein receiving the user input data further includes applying a natural language processing (NLP) technique to the audio signal to determine the selection of the sector of the plurality of sectors.

20. The computer program product of claim 15, wherein the instructions, when executed by the at least one processor, further cause the at least one processor to:
receive, from the user device, further user input data associated with an identification of the user in the one or more images; and
determine, based on the identified user, a location of the user in an environment surrounding the autonomous vehicle.
